(19) United States
(12) Patent Application Publication
(10) Pub. No.: US 2026/0309977 A1
(43) Pub. Date: Oct. 8, 2026

(54) DRIVING CIRCUIT FOR MICROELECTROMECHANICAL SYSTEMS (MEMS) MICROMIRRORS

(71) Applicant: Molex, LLC, Lisle, IL (US)

(72) Inventor: Longgang Huang, Fremont, CA (US)

(21) Appl. No.: 19/640,615

(22) Filed: Apr. 7, 2026

Related U.S. Application Data
(60) Provisional application No. 63/784,343, filed on Apr. 7, 2025.

(51) Int. Cl. G02B 26/08

(52) U.S. Cl. CPC G02B 26/0833

(57) ABSTRACT

An electronic device includes a driver integrated circuit (IC) configured to transmit one or more driving signals to a microelectromechanical systems (MEMS) micromirror. The MEMS micromirror includes a first digital to analog converter (DAC) configured to generate a first voltage signal for supplying to one of a first electrode or a second electrode of the MEMS micromirror. The MEMS micromirror further includes a first selection component configured to receive the first voltage signal generated by the first DAC, receive a second voltage signal, and selectively supply the first voltage signal to one of the first electrode or the second electrode and the second voltage signal to the other of the first electrode or the second electrode to control a tilt of the MEMS micromirror.

### FIELD OF THE INVENTION

The present disclosure relates generally to microelectromechanical systems (MEMS) micromirrors, and, more specifically, to a system and method for providing an improved driving circuit for MEMS micromirrors.

### BACKGROUND

Microelectromechanical systems (MEMS) micromirrors are miniaturized devices produced with microfabrication techniques, such as silicon micromachining, thin-film deposition, and lithography, incorporating all the mechanical, electrical and optical components required for the precise control over the direction of reflected light. For example, in optical communication systems, MEMS micromirrors may be utilized for efficient wavelength switching and optical signal routing in fiberoptic networks. MEMS micromirrors generally consist of several components that function together to ensure an accurate reorientation of incident light. For example, a MEMS micromirror may include a mirror plate, which serves to reflect the incoming light. The mirror plate may be connected to a surrounding structure by hinges, flexural beams, or torsional springs that enable the mirror plate to rotate around or tilt along one or more orthogonal axes. A driving circuit may be utilized to control the rotation or the tilting of the mirror plate in a desired manner.

### SUMMARY

According to one embodiment, an electronic device includes a driver integrated circuit (IC) configured to transmit one or more driving signals to a microelectromechanical systems (MEMS) micromirror. The MEMS micromirror includes a first digital to analog converter (DAC) configured to generate a first voltage signal for supplying to one of a first electrode or a second electrode of the MEMS micromirror. The MEMS micromirror further includes a first selection component configured to receive the first voltage signal generated by the first DAC, receive a second voltage signal, and selectively supply the first voltage signal to one of the first electrode or the second electrode and the second voltage signal to the other of the first electrode or the second electrode to control a tilt of the MEMS micromirror.

According to another embodiment, a method implemented by an application-specific integrated circuit (ASIC) includes generating, by a first DAC of the ASIC, a first voltage signal for supplying to one of a first electrode or a second electrode of a MEMS micromirror, receiving, by a first selection component of the ASIC, the first voltage signal generated by the first DAC, receiving, by the first selection component, a second voltage signal, and selectively supplying, by the first selection component, the first voltage signal to one of the first electrode or the second electrode and the second voltage signal to the other of the first electrode or the second electrode to control a tilt of the MEMS micromirror.

According to another embodiment, a method for fabricating an electronic device includes forming a first substrate, disposing onto a first side of the first substrate one or more MEMS micromirrors, and disposing onto a second side of the first substrate one or more driver IC dies configured to transmit one or more driving signals to the one or more MEMS micromirrors. Each of the one or more driver IC dies includes a first DAC configured to generate a first voltage signal for supplying to one of a first electrode or a second electrode electrically coupled to the one or more MEMS micromirrors. Each of the one or more driver IC dies further includes a first selection component configured to selectively supply the first voltage signal or a second voltage signal to one of the first electrode or the second electrode and a second voltage signal to the other of the first electrode or the second electrode to control a tilt of the one or more MEMS micromirrors. The one of the first electrode or the second electrode electrically couples the first selection component to the one or more MEMS micromirrors.

According to another embodiment, a non-transitory computer-readable medium includes instructions that, when executed by an ASIC, cause the ASIC to generate, by a first DAC of the ASIC, a first voltage signal for supplying to one of a first electrode or a second electrode of a MEMS micromirror, receive, by a first selection component of the ASIC, the first voltage signal generated by the first DAC, receive, by the first selection component, a second voltage signal, and selectively supply, by the first selection component, the first voltage signal to one of the first electrode or the second electrode and the second voltage signal to the other of the first electrode or the second electrode to control a tilt of the MEMS micromirror.

These and other advantages will be described more fully in the following detailed description.

### BRIEF DESCRIPTION OF THE DRAWINGS

In order to facilitate a fuller understanding of the present disclosure, reference is now made to the attached drawings. The drawings should not be construed as limiting the present disclosure but are intended only to illustrate different aspects and embodiments of the disclosure.

FIG. 1 illustrates a schematic diagram of a driver integrated circuit (IC) system for a microelectromechanical systems (MEMS) micromirror, in accordance with one or more embodiments of the present disclosure.

FIG. 2 illustrates another schematic diagram of a driver IC system for a MEMS micromirror, in accordance with one or more embodiments of the present disclosure.

FIG. 3 illustrates another schematic diagram of a driver IC system for controlling a voltage step size and duration of a driving signal for a MEMS micromirror, in accordance with one or more embodiments of the present disclosure.

FIG. 4 illustrates a voltage timing diagram for controlling a voltage step size and duration of a driving signal for a MEMS micromirror, in accordance with one or more embodiments of the present disclosure.

FIG. 5 illustrates a block diagram of a MEMS micromirror array and driver circuitry system including one or more driver ICs for providing driving signals to a MEMS micromirror array disposed on a substrate, in accordance with the prior art.

FIGS. 6A and 6B illustrate a block diagram of a MEMS micromirror array and driver circuitry system including one or more driver ICs and a MEMS micromirror array each disposed on either side of a substrate, a primary substrate base, and a secondary substrate base, respectively, in accordance with one or more embodiments of the present disclosure.

FIG. 7 illustrates a block diagram of a MEMS micromirror array and driver circuitry system including one or more driver ICs and a MEMS micromirror array disposed on either side of a silicon wafer, in accordance with one or more embodiments of the present disclosure.

FIG. 8 illustrates an example computing system, in accordance with one or more embodiments of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. It will, however, be apparent to those skilled in the art that these concepts may be practiced without these specific details. In some instances, well-known structures and components are shown in block diagram form in order to avoid obscuring such concepts.

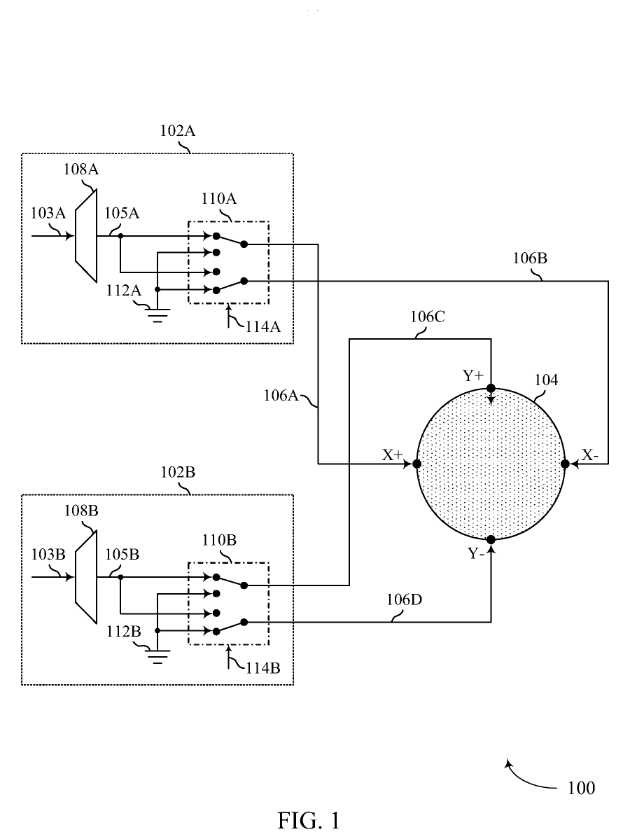

FIG. 1 illustrates a schematic diagram of a driver integrated circuit (IC) system 100 for a microelectromechanical systems (MEMS) micromirror, in accordance with one or more embodiments of the present disclosure. In one embodiment, the driver IC system 100 may include one of an application-specific integrated circuit (ASIC), a field-programmable gate array (FPGA), a microcontroller, or other similar dedicated microprocessor that may be suitable for transmitting one or more voltage signals 106A, 106B, 106C, and 106D (e.g., driving signals) to a MEMS micromirror 104. As depicted by FIG. 1, the driver IC system 100 may include a first driver IC 102A, a second driver IC 102B, and the MEMS micromirror 104. In one embodiment, the MEMS micromirror 104 may include, for example, a linear MEMS micromirror, a quasi-static MEMS micromirror, or a resonant MEMS micromirror.

In particular embodiments, the first driver IC 102A may include a first digital to analog converter (DAC) 108A suitable for generating a first analog voltage signal 105A (e.g., based on a digital input signal 103A) for supplying to one of a first electrode or a second electrode of the MEMS micromirror 104. Similarly, the second driver IC 102B may include a second digital to analog converter (DAC) 108B suitable for generating a second analog voltage signal 105B (e.g., based on a digital input signal 103B) for supplying to one of a third electrode or a fourth electrode of the MEMS micromirror 104. For example, in one embodiment, the first DAC 108A may include any device suitable for supplying the first analog voltage signal 105A to one of two electrodes of the MEMS micromirror 104 in order to create an electrostatic force that causes a mirror plate of the MEMS micromirror 104 to tilt in one of a first direction (e.g., “X+” direction) or a second direction (e.g., “X-” direction). The second DAC 108B may include any device suitable for supplying the second analog voltage signal 105B to one of two electrodes of the MEMS micromirror 104 in order to create an electrostatic force that causes the mirror plate of the MEMS micromirror 104 to tilt in one of a third direction (e.g., “Y+” direction) or a fourth direction (e.g., “Y-” direction).

In particular embodiments, the first DAC 108A and the second DAC 108B may each include, for example, a resistive DAC (R-DAC and/or R-2R DAC) (e.g., resistor string DAC), a capacitive DAC (CDAC), a binary-weighted DAC (BDAC), a serial DAC (SDAC), a Pulse Width Modulation (PWM) DAC, a Pulse Density Modulation (PDM) DAC, or other similar DAC architecture that may be useful in outputting an analog voltage signal for controlling one or more directional tilts of the mirror plate of the MEMS micromirror 104. In particular embodiments, as further depicted by FIG. 1, the first driver IC 102A may include a first selection component (e.g., a first multiplexer (MUX), a first switch, or a first selector), and the second driver IC 102B may include a second selection component (e.g., a second MUX, a second switch, or a second selector). In the example of FIG. 1, the first driver IC 102A may include a first MUX 110A, and the second driver IC 102B may include a second MUX 110B. In particular embodiments, the first MUX 110A may receive the first analog voltage signal 105A generated by the first DAC 108A and receive a first ground voltage signal 112A, which may include a ground voltage (e.g., approximately “0 volts (V)”). For example, the first analog voltage signal 105A and the first ground voltage signal 112A may be inputs to the first MUX 110A.

A first voltage signal 106A and a second voltage signal 106B may be outputs of the first MUX 110A. The first voltage signal 106A may be a voltage signal output to a first electrode (e.g., an “X+” electrode) of the MEMS micromirror 104, and the second voltage signal 106B may be a voltage signal output to a second electrode (e.g., an “X-” electrode) of the MEMS micromirror 104. The first voltage signal 106A may be the first analog voltage signal 105A or the first ground voltage signal 112A based on a control signal 114A. For example, the control signal 114A may cause the first MUX 110A to output the first analog voltage signal 105A as the first voltage signal 106A based on coupling a signal path (e.g., conductive line) to the first electrode of the MEMS micromirror 104 with the first analog voltage signal 105A input. That is, the control signal 114A may cause the first MUX 110A to route the first analog voltage signal 105A to the first electrode. Alternatively, the control signal 114A may cause the first MUX 110A to output the first ground voltage signal 112A as the first voltage signal 106A, for example, based on coupling the conductive line to the first electrode with the first ground voltage signal 112A input. Similarly, the second voltage signal 106B may be the first analog voltage signal 105A or the first ground voltage signal 112A based on the control signal 114A coupling a signal path to the second electrode of the MEMS micromirror 104 to a corresponding input.

The first MUX 110A may control the tilt of the MEMS micromirror 104 in the first (“X+”) and second (“X-”) directions by controlling which of the first analog voltage signal 105A and the first ground voltage signal 112A is output to the first electrode as the first voltage signal 106A and which of the first analog voltage signal 105A and the first ground voltage signal 112A is output to the second electrode as the second voltage signal 106B. For example, the first MUX 110A may output the first analog voltage signal 105A to the first electrode or the second electrode and the first ground voltage signal 112A to the remaining electrode. To control the tilt of the MEMS micromirror 104 in the first direction (e.g., “X+” direction) as shown in the example of FIG. 1, the first MUX 110A may supply the first analog voltage signal 105A as the first voltage signal 106A to the first electrode (e.g., the “X+” electrode) and the first ground voltage signal 112A as the second voltage signal 106B to the remaining electrode, i.e., the second electrode (e.g., the “X+” electrode). Conversely, to control the tilt of the MEMS micromirror 104 in the second direction (e.g., “X-” direction), the first MUX 110A may supply the first analog voltage signal 105A as the second voltage signal 106B to the second electrode (e.g., the “X-” electrode) and the first ground voltage signal 112A as the first voltage signal 106A to the first electrode (e.g., the “X+” electrode). In some examples, the MEMS micromirror 104 may not be driven in either the first direction or the second direction (e.g., the MEMS micromirror 104 may be in an idle state, at least with respect to the X direction). Here, the first MUX 110A may supply the first ground voltage signal 112A as both the first voltage signal 106A and the second voltage signal 106B.

Similarly, the second MUX 110B may receive (e.g., as an input) the second analog voltage signal 105B generated by the second DAC 108B and receive (e.g., as an input) a second ground voltage signal 112B, which may include a ground voltage (e.g., approximately “0V”). A third voltage signal 106C and a fourth voltage signal 106D may be outputs of the second MUX 110B. The third voltage signal 106C may be a voltage signal output to a third electrode (e.g., a “Y+” electrode) of the MEMS micromirror 104, and the fourth voltage signal 106D may be a voltage signal output to a fourth electrode (e.g., a “Y-” electrode) of the MEMS micromirror 104. Similar to the first MUX 110A, the third voltage signal 106C may be the second analog voltage signal 105B or the second ground voltage signal 112B based on a control signal 114B. For example, the control signal 114B may cause the second MUX 110B to output the second analog voltage signal 105B or the second ground voltage signal 112B as the third voltage signal 106C based on coupling a signal path (e.g., conductive line) to the third electrode of the MEMS micromirror 104. That is, the control signal 114B may cause the second MUX 110B to route either the second analog voltage signal 105B or the second ground voltage signal 112B to the third electrode. Similarly, the fourth voltage signal 106D may be the second analog voltage signal 105B or the second ground voltage signal 112B based on the control signal 114B coupling a signal path to the fourth electrode of the MEMS micromirror 104 to a corresponding input.

The second MUX 110B may similarly control the tilt of the MEMS micromirror 104 in the third (“Y-”) and fourth (“Y+”) directions by controlling which of the second analog voltage signal 105B or the second ground voltage signal 112B is output to the third electrode and which of the second analog voltage signal 105B or the second ground voltage signal 112B is output to the fourth electrode (e.g., based on the control signal 114B). To control the tilt of the MEMS micromirror 104 in the third direction (e.g., “Y+” direction) as shown in FIG. 1, the second MUX 110B may selectively supply the second analog voltage signal 105B as the third voltage signal 106C to the third electrode (e.g., “Y+” electrode) and the second ground voltage signal 112B as the fourth voltage signal 106D to the fourth electrode (e.g., the “Y-” electrode). Conversely, to control the tile of the MEMS micromirror 104 in the fourth direction (e.g., “Y-” direction), the second MUX 110B may supply the second ground voltage signal 112B as the third voltage signal 106C to the third electrode (e.g., the “Y+” electrode) and the second analog voltage signal 105B as the fourth voltage signal 106D to the fourth electrode (e.g., the “Y-” electrode).

It should be appreciated that which of the first voltage signal 106A or the second voltage signal 106B that includes the analog voltage signal or the ground voltage signal may alternately switch based on the intended tilt direction of the MEMS micromirror 104. Similarly, which of the third voltage signal 106C or the fourth voltage signal 106D that includes the analog voltage signal or the ground voltage signal may alternately switch based on the intended tilt direction of the MEMS micromirror 104.

Thus, in accordance with the presently disclosed embodiments, a single DAC 108A, 108B provides an analog voltage output (e.g., analog voltage signal 105A, 105B) to a MUX 110A, 110B to drive two opposing electrodes of the MEMS micromirror 104. The present embodiments thus leverage the physical property of the electrode pairs of the MEMS micromirror 104 in which only one electrode in an electrode pair is actively driven at a time. The MUXs 110A, 110B directs the DAC 108A, 108B analog voltage output to the active electrode in the electrode pair while the other electrode in the electrode pair is grounded. This reduces the number of DACs 108A, 108B that any one driver IC 102A, 102B may include. In particular embodiments, the switching of the MUXs 110A, 110B may each be controlled via respective control signals 114A, 114B.

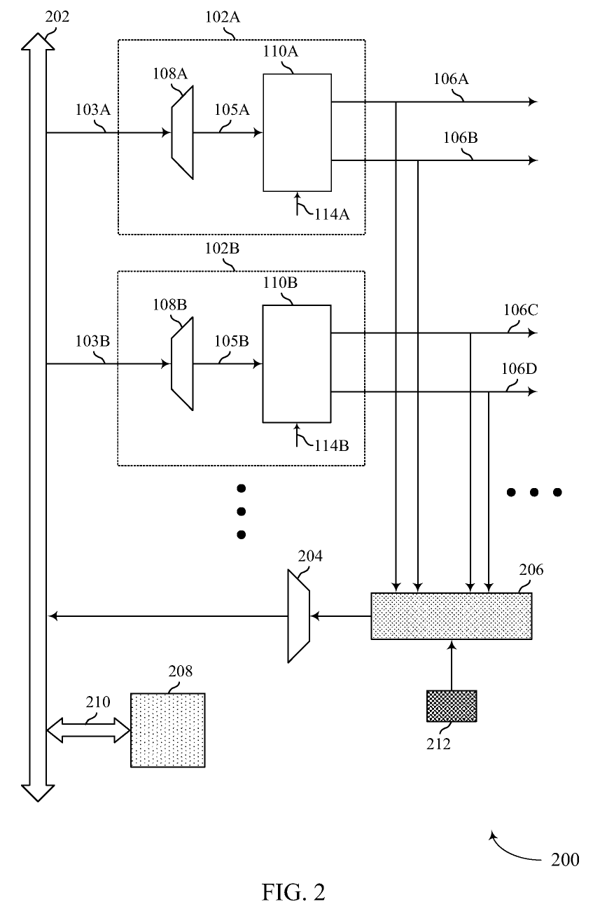

FIG. 2 illustrates another schematic diagram of a driver IC system 200 for a MEMS micromirror, in accordance with one or more embodiments of the present disclosure. In one embodiment, driver IC system 200 may operate in a similar or quasi-similar manner to the driver IC system 100 as discussed above with respect to FIG. 1. In particular embodiments, in addition to the first driver IC 102A and the second driver IC 102B as generally discussed above with respect to the driver IC system 100, the driver IC system 200 as illustrated may further include a digital data bus 202, an analog to digital converter (ADC) 204, a MUX 206, and internal memory 208.

In particular embodiments, the ADC 204 may be utilized to perform an autocalibration of the first DAC 108A based on one or more of the first voltage signal 106A or the second voltage signal 106B. Similarly, the ADC 204 may be further utilized to perform an autocalibration of the second DAC 108B based on one or more of the third voltage signal 106C or the fourth voltage signal 106D and so on and so forth for any number of DACs 108A, 108B. For example, the ADC 204 may first be calibrated using the voltage from a precise internal or external calibration voltage. In particular, the readings (e.g., outputs, responses, measured voltages) of the ADC 204 may be compared against a reference voltage source 212 (e.g., an ideal voltage source, which may be an “internal calibration voltage” or an “external calibration voltage”). For example, because of the intrinsic error of the ADC 204, the ADC’s measured voltage may deviate from the reference voltage input, thereby exhibiting a delta error (e.g., a “Delta-V error”). In some examples, the delta error may be the voltage measured by the ADC 204 minus the reference voltage (e.g., internal or external). As such, the delta error may be positive or negative. If the reference voltage input was 5.0V and the ADC 204 measured voltage was 4.5V, for example, the Delta-V error would be -0.5V (e.g., 4.5V – 5.0V = -0.5V). In some examples, the expected voltage value (e.g., “internal calibration voltage” or “external calibration voltage”) may be selected by a user or an operator of the driver IC system 200 based on a desired degree value or a precise degree value to which the MEMS micromirror 104 is intended to tilt any particular direction.

The difference between the measured (e.g., actual) values of the ADC 204 and the reference voltage (e.g., the Delta-V error) may be stored to internal memory 208 and used to correct subsequent ADC readings. The stored difference may be an example of a correction factor 210 (e.g., an ADC correction factor) that is stored to the internal memory 208 and used to correct ADC readings. In some examples, because calibrations may be executed at specific sampled voltages, a linear approximation method may be implemented for the voltage points not directly calibrated by utilizing the two neighboring (e.g., adjacent) sampled voltages. After the ADC 204 is calibrated, it may be used to precisely measure the voltage produced by a DAC. For example, the difference (e.g., Delta-V error) may be used to correct the ADC 204’s inherent error when it later measures the DAC output during the subsequent DAC calibration stage.

With the ADC 204 calibrated, it may operate as a precise voltmeter in the calibration stage of a DAC. For instance, the stored ADC calibration delta (e.g., the Delta-V error) may be applied to the measured DAC output to correct for any inherent ADC measurement errors. For example, the actual DAC output voltage may be calculated as: Actual DAC Output Voltage = Voltage Measured by ADC 204 - Delta-V. To perform an autocalibration of the first DAC 108A, the MUX 206 may selectively output a voltage signal 106 (e.g., the first voltage signal 106A or the second voltage signal 106B) to the ADC 204. The ADC 204 may output a measured voltage value based on the voltage signal 106 received from the MUX 206.

The measured voltage value output by the ADC 204 may be used to calibrate the first DAC 108A. For example, for an ideal DAC that has no intrinsic errors, the ideal curve representing the DAC output voltage as a function of the DAC digital setting (e.g., DAC digital input) may be a straight line, for example, represented by y (DAC output) = x (DAC digital setting)). To generate an expected output of 6.0V, for example, the ideal DAC setting would be DAC-Ideal, where DAC-Ideal may be calculated from this linear, straight-line function. Because the DAC 108A is not an ideal DAC, the DAC Output Voltage as a function of the DAC digital setting may be non-linear. So if DAC-Ideal is set at the input of the DAC 108A, the DAC 108A may output, for example, 6.5V, corresponding to an output error of 0.5V.

To correct the DAC intrinsic error, the driver IC system 200 (e.g., the firmware of the driver IC system 200) may modify (e.g., vary) the DAC digital setting to determine the actual DAC digital setting (“DAC-Actual) that yields the expected output voltage 6.0V. For example, the driver IC system 200 may vary the DAC digital setting until the ADC 204 measures 6.0V, and the DAC digital setting that yielded the 6.0V measurement may be DAC-Actual. The delta error of the DAC 108A (e.g., “Delta-D error”) may be the difference between DAC-Ideal and DAC-Actual. That is, Delta-D = DAC-Ideal – DAC-Actual. As such, the delta error may be positive or negative. During normal operation of the DAC 108A, DAC-Actual may be determined and used to generate a desired DAC output. For example, DAC-Actual may be determined by: DAC-Actual = DAC-Ideal – Delta-D. The Delta-D error may be stored to internal memory 208. The stored Delta-D error may be an example of a correction factor 210 (e.g., a DAC correction factor) that is stored to the internal memory 208 and used to generate desired DAC outputs.

Similar procedures may be used to calibrate the DAC 108B.

Because the DAC calibrations are performed at designated sampled DAC digital settings, for expected DAC output voltage settings where calibration data is unavailable (e.g., for which there are no corresponding correction factors 210), the driver IC system 200 may use linear approximation, interpolating between data points (e.g., correction factors 210) from two adjacent calibrated expected output voltages.

Additionally, due to the temperature dependency of ADC and DAC intrinsic errors, the calibrations may be conducted across multiple temperature points. Resulting correction factors 210 (e.g., voltage (Delta-V) and digital (Delta-D) correction factors) may be stored in memory (e.g., to the internal memory 208). During field operation, the driver IC system 200’s internal temperature sensor enables the selection and application of the appropriate Delta-V and Delta-D values for dynamic DAC output calibration. For temperatures where calibration data is unavailable (e.g., for which there are no corresponding correction factors 210), the driver IC system 200 may use linear approximation, interpolating between data points (e.g., correction factors 210) from two adjacent calibrated temperatures.

Thus, in accordance with the presently disclosed embodiments, the ADC 204 is initially self-calibrated using an internal or external voltage reference. Each of the DACs 108A, 108B may be then calibrated by measuring the output voltage of the DACs 108A, 108B against the ADC 204 under various voltage settings and apply the Delta-D to calibrate the DAC-Ideal to generate the desired DAC output. The differences may be further utilized for automatic (e.g., real-time) calibration of the DACs 108A, 108B during normal operation. The autocalibration techniques thus effectively compensate for DAC 108A, 108B nonlinearities, errors, and drift, for example. Additionally, because calibrations are performed at designated sampled DAC digital settings, a linear approximation technique may be employed for those digital settings that are not directly calibrated, by leveraging the two neighboring (e.g., adjacent) sampled digital settings. Further temperature dependent intrinsic error drifts may be calibrated by applying linear approximation techniques among the calibrated data under sampled temperature. That is, the driver IC system 200 may interpolate between neighboring temperature points to determine correction factors for temperatures for which calibration has not been performed directly.

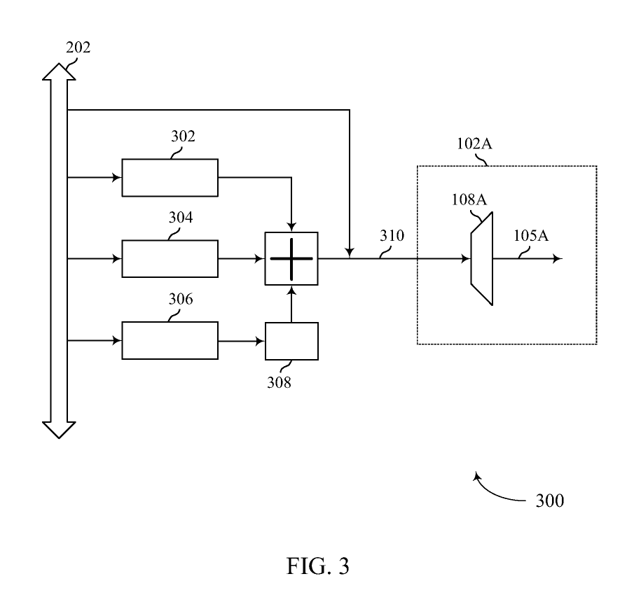

FIG. 3 illustrates another schematic diagram of a driver IC system 300 for controlling a voltage step size and duration of a driving signal for a MEMS micromirror, in accordance with one or more embodiments of the present disclosure. As depicted by FIG. 3, the driver IC system 300 may include the first driver IC 102A, the digital data bus 202, a number of voltage steps 302 that may be stored to one or more programmable registers on the first driver IC 102A or one or more programmable registers communicatively coupled to the first driver IC 102A, a voltage step size 304, a time step 306, and a timer 308 that may be communicatively coupled to the first driver IC 102A. In particular embodiments, a control logic of the driver IC system 300 may be utilized to adjust one or more of the first voltage signal 106A or the second voltage signal 106B, for example, by controlling the number of voltage steps 302, the voltage step size 304, the time step 306 of an input voltage 310 to the first DAC 108A as the input voltage 310 is supplied to the first DAC 108A.

For example, in one embodiment, the one or more programmable registers may store the number of voltage steps 302, the voltage step size 304, and the time step 306 (e.g., duration) and the control logic may utilize the number of voltage steps 302, the voltage step size 304, and the time step 306 (e.g., duration) to control an increase or decrease in the analog voltage signal outputted by the first DAC 108A to avoid exciting the resonance frequencies of the MEMS micromirror 104. Specifically, in order to control the tilt of the MEMS micromirror 104 to a linear motion profile, for example, the control logic may adjust (e.g., scale) one or more of the first voltage signal 106A or the second voltage signal 106B by controlling the voltage step size 304 and the time step 306 (e.g., duration) for each of the number of voltage steps 302 corresponding to an increase or decrease in the analog voltage signal outputted by the first DAC 108A.

In one embodiment, the voltage step size 304 and the time step 306 (e.g., duration) may each include a binary value (e.g., binary input code) by which the input voltage 310 may be scaled as the input voltage 310 is supplied to the first DAC 108A, and may thereby control the increase or decrease in output voltage of the first DAC 108A to a stepped output voltage as opposed to an analog voltage signal sharply increasing or decreasing over time. That is, any increase or decrease in output voltage of the first DAC 108A may occur as a controlled discrete signal as opposed to a step signal. In this way, the present embodiments reduce the potential for an excitation of resonances (e.g., mechanical resonances) of the MEMS micromirror 104, and further compensate for nonlinear characteristics of the electromechanical dynamics associated with tilting the MEMS micromirror 104.

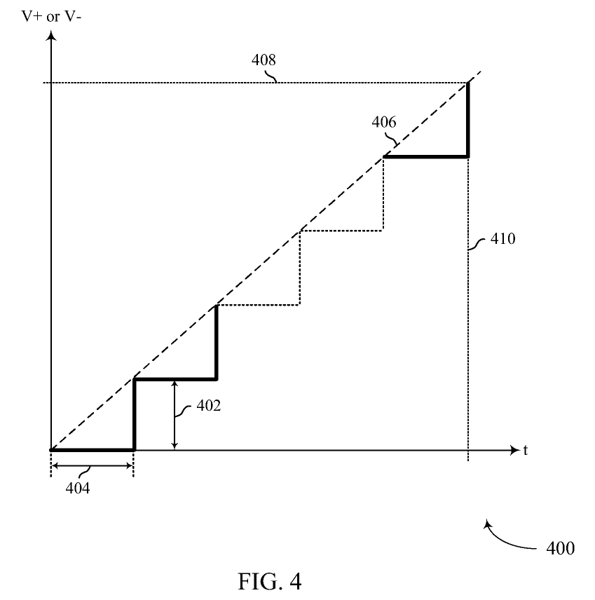

FIG. 4 illustrates a voltage timing diagram 400 for controlling the voltage step 402 and time step 404 (e.g., duration) of an input driving signal for a MEMS micromirror, in accordance with one or more embodiments of the present disclosure. Specifically, as generally discussed above with respect to FIG. 3, the voltage timing diagram 400 illustrates a running example of the control logic adjusting (e.g., scaling) one or more of the first voltage signal 106A or the second voltage signal 106B, for example, by controlling the number of voltage steps 302, the voltage step size 304, the time step 306 of the input voltage 310. Specifically, as depicted by voltage timing diagram 400, instead of the first DAC 108A outputting an analog voltage signal 406 that continuously and linearly increases over time, the output voltage of the first DAC 108A is controlled in accordance with the scaling of the input voltage (e.g., input voltage 310) by the voltage step 402 and the time step 404 (e.g., duration). That is, as depicted by the voltage timing diagram 400, the increase in output voltage of the first DAC 108A is controlled to a stepped output voltage (e.g., to a voltage setting target 408 over the duration of time setting target 410) as opposed to the analog voltage signal 406 that increase or decrease over time as a step function.

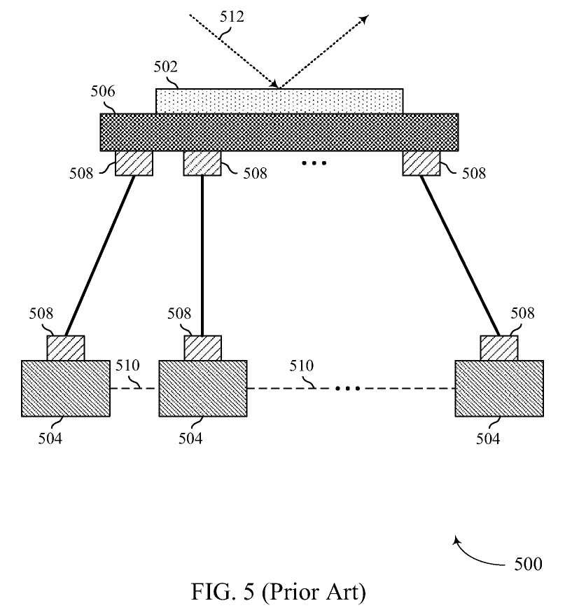

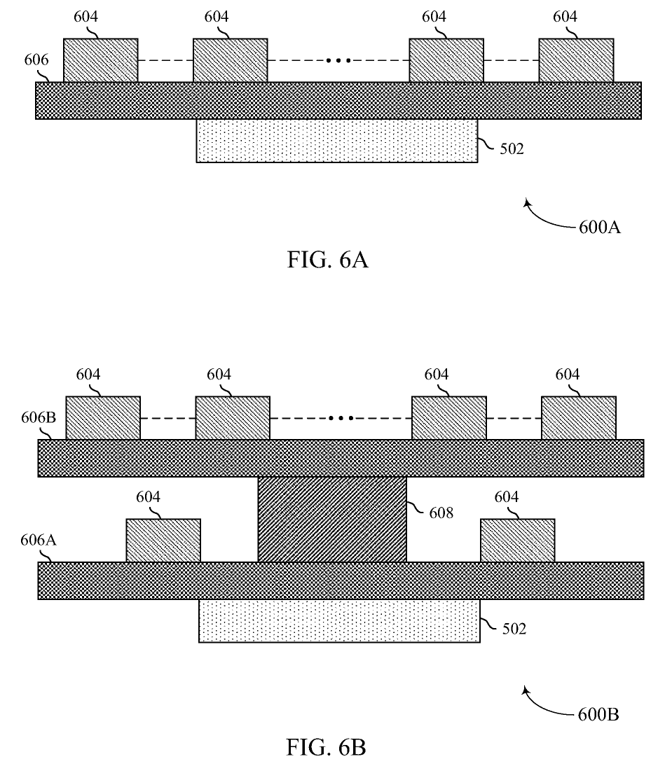

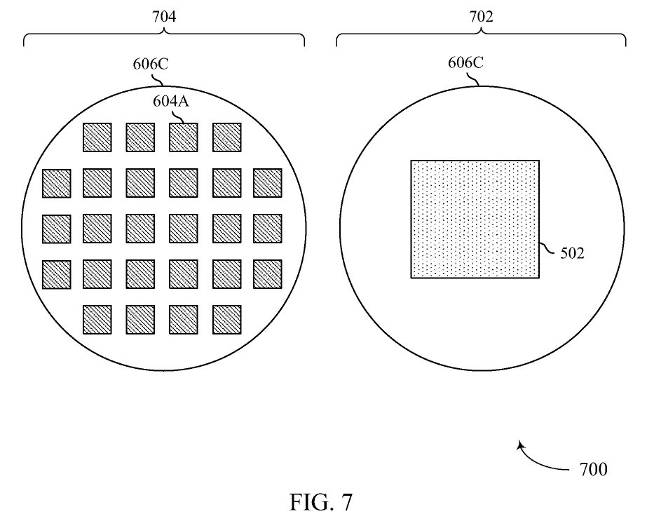

FIG. 5 illustrates a block diagram of a MEMS micromirror array and driver circuitry system 500 including one or more driver ICs for providing driving signals to a MEMS micromirror array disposed on a substrate 506, in accordance with the prior art. FIGS. 6A and 6B illustrate a block diagram of a MEMS micromirror array and driver circuitry system 600A, 600B including one or more driver ICs 604 and a MEMS micromirror array 502 each disposed on either side of a substrate 506, a primary substrate base 606A, and a secondary substrate base 606B, respectively, in accordance with one or more embodiments of the present disclosure. FIG. 7 illustrates a block diagram of a MEMS micromirror array and driver circuitry system 700 including one or more driver ICs 604 and a MEMS micromirror array 502 disposed on either side of a silicon wafer, in accordance with one or more embodiments of the present disclosure. For the purposes of illustration and conciseness, FIGS. 5, 6A, 6B and 7, are discussed in conjunction herein.

In FIG. 5, fabricating the MEMS micromirror array and driver circuitry system 500 may begin with forming a substrate 506. A MEMS micromirror array 502 (e.g., configured to direct an optical beam 512) may be disposed on a top side of the substrate 506, and a number of driving cards 504 may be disposed on a bottom side of the substrate 506 (e.g., and connected by cables 510). The driving cards 504 are configured to transmit one or more driving signals to the MEMS micromirror array 502. Each driving card 504 is a physical Printed Circuit Board (PCB) that includes multiple packaged ICs. Conductive traces 508 may be disposed on the bottom side of the substrate 506 to couple the driving cards 504 with the MEMS micromirror array 502.

In particular embodiments, the MEMS micromirror array and driver circuitry system 600A, 600B and the MEMS micromirror array and driver circuitry system 700 may be fabricated and/or constructed in accordance with the presently disclosed embodiments for purposes of minimizing interconnection cabling complexity, thereby improving system reliability and compactness. The MEMS micromirror array and driver circuitry systems 600A, 600B, 700 may also be fabricated and/or constructed for purposes of reducing the physical area and power consumption and increasing the processing speed of the MEMS micromirror array and driver circuitry system 600A, 600B, 700.

In particular embodiments, fabricating and/or constructing the MEMS micromirror array and driver circuitry system 600A, 600B, 700 may begin with forming a substrate 606. In one embodiment, the substrate 606 may include a silicon (Si) substrate, a ceramic substrate, gallium-nitride (GaN) substrate, a graphene substrate, a silicon-oxide (SiO2) substrate, or other similar substrate materials. In another embodiment shown in FIG. 7, the substrate 606 may include a single substrate wafer 606C, which may include one or more bonding pads on which to dispose the MEMS micromirror array 502, one or more filtering components, and one or more conductive traces 508. In another embodiment shown in FIG. 6B, the substrate 606 may include a primary substrate base 606A (e.g., “main substrate base”) for the MEMS micromirror array and driver circuitry system 600B and/or a secondary substrate base 606B (e.g., “daughter substrate base”) that may, for example, be peripheral to the primary substrate base 606A (e.g., “main substrate base”). In some example embodiments, the primary substrate base 606A and the secondary substrate base 606B may be coupled via a ball grid array (“BGA”) pin 608.

In particular embodiments, fabricating and/or constructing the MEMS micromirror array and driver circuitry system 600A, 600B, 700 may further include disposing onto a first side (e.g., top side 702) of the substrate 606 a MEMS micromirror array 502. In particular embodiments, fabricating and/or constructing the MEMS micromirror array and driver circuitry system 600A, 600B, 700 may further include disposing onto a second side (e.g., bottom side 704) of the substrate 606 a number of driver IC dies 604 (e.g., an array of driver IC dies 604A) suitable for transmitting one or more driving signals to the MEMS micromirror array 502.

In accordance with the presently disclosed embodiments, each of the number of driver IC dies 604 (e.g., an array of driver IC dies 604A) may include one or more DACs (e.g., first DAC 108A, second DAC 108B) that may be suitable for generating one or more analog voltage signals (e.g., first analog voltage signal 105A, second analog voltage signal 105B) for supplying to electrodes electrically coupled to each respective MEMS micromirror (e.g., MEMS micromirror 104) of the MEMS micromirror array 502. In particular embodiments, each of the number of driver IC dies 604 (e.g., an array of driver IC dies 604A) may further include one or more selection components (e.g., first MUX 110A, second MUX 110B) that may be suitable for selectively supplying the one or more analog voltage signals to the electrodes to control a tilt of each of the respective MEMS micromirrors (e.g., MEMS micromirror 104) of the MEMS micromirror array 502 in one or more directions. In one embodiment, disposing onto the second side (e.g., bottom side) of the substrate 606 the number of driver IC dies 604 (e.g., an array of driver IC dies 604A) may include disposing onto the second side (e.g., bottom side) of the substrate 606 the number of driver IC dies 604 (e.g., an array of driver IC dies 604A) utilizing one or more of a wire-bonding process or a flip-chip bonding process.

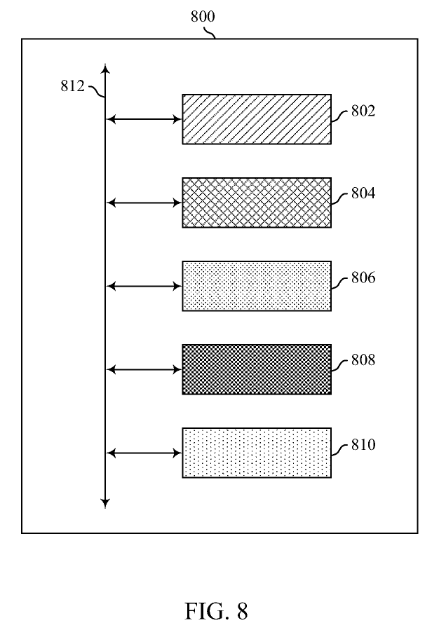

FIG. 8 illustrates an example computer system 800 that may be useful in performing one or more of the foregoing techniques as presently disclosed herein. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein.

As an example, and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate. In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example, and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example, and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802.

Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example, and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere).

One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example, and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it.

As an example, and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

The following provides an overview of aspects of the present disclosure:

Aspect 1: An electronic device, comprising: a driver IC configured to transmit one or more driving signals to a MEMS micromirror, comprising: a first DAC configured to generate a first voltage signal for supplying to one of a first electrode or a second electrode of the MEMS micromirror; and a first selection component configured to: receive the first voltage signal generated by the first DAC; receive a second voltage signal; and selectively supply the first voltage signal to one of the first electrode or the second electrode and the second voltage signal to the other of the first electrode or the second electrode to control a tilt of the MEMS micromirror.

Aspect 2: The electronic device of aspect 1, wherein the first voltage signal is configured to cause the MEMS micromirror to tilt in a first direction when supplied to the first electrode and to tilt in a second direction when supplied to the second electrode.

Aspect 3: The electronic device of any of aspects 1 through 2, wherein the second voltage signal comprises a ground voltage signal.

Aspect 4: The electronic device of any of aspects 1 through 3, wherein the driver IC comprises a first driver IC, and wherein the electronic device further comprises: a second driver IC configured to transmit one or more driving signals to the MEMS micromirror, comprising: a second DAC configured to generate a third voltage signal for supplying to one of a third electrode or a fourth electrode of the MEMS micromirror; and a second selection component configured to: receive the third voltage signal generated by the second DAC; receive a fourth voltage signal; and selectively supply the third voltage signal to one of the third electrode or the fourth electrode and the fourth voltage signal to the other of the third electrode or the fourth electrode to control another tilt of the MEMS micromirror.

Aspect 5: The electronic device of aspect 4, wherein the third voltage signal is configured to cause the MEMS micromirror to tilt in a third direction when supplied to the third electrode and to tilt in a fourth direction when supplied to the fourth electrode.

Aspect 6: The electronic device of any of aspects 1 through 5, wherein the first selection component is further configured to selectively supply the first voltage signal and the second voltage signal based at least in part on a received control signal.

Aspect 7: The electronic device of any of aspects 1 through 6, further comprising an ADC configured to perform an autocalibration of the first DAC based at least in part on the first voltage signal or the second voltage signal.

Aspect 8: The electronic device of any of aspects 1 through 7, wherein the driver IC comprises one of an ASIC, an FPGA, or a microcontroller.

Aspect 9: The electronic device of any of aspects 1 through 8, wherein the first selection component is a MUX, a switch, or a selector.

Aspect 10: A method implemented by an ASIC, the method comprising: generating, by a first DAC of the ASIC, a first voltage signal for supplying to one of a first electrode or a second electrode of a MEMS micromirror; receiving, by a first selection component of the ASIC, the first voltage signal generated by the first DAC; receiving, by the first selection component, a second voltage signal; and selectively supplying, by the first selection component, the first voltage signal to one of the first electrode or the second electrode and the second voltage signal to the other of the first electrode or the second electrode to control a tilt of the MEMS micromirror.

Aspect 11: The method of aspect 10, wherein the first voltage signal is configured to cause the MEMS micromirror to tilt in a first direction when supplied to the first electrode and to tilt in a second direction when supplied to the second electrode.

Aspect 12: The method of any of aspects 10 through 11, wherein receiving the second voltage signal comprises receiving, by the first selection component, a ground voltage signal.

Aspect 13: The method of any of aspects 10 through 12, further comprising: generating, by a second DAC of the ASIC, a third voltage signal for supplying to one of a third electrode or a fourth electrode of the MEMS micromirror; receiving, by a second selection component of the ASIC, the third voltage signal generated by the second DAC; receiving, by the second selection component, a fourth voltage signal; and selectively supplying, by the second selection component, the third voltage signal to one of the third electrode or the fourth electrode and the fourth voltage signal to the other of the third electrode or the fourth electrode to control another tilt of the MEMS micromirror.

Aspect 14: The method of aspect 13, wherein the third voltage signal is configured to cause the MEMS micromirror to tilt in a third direction when supplied to the third electrode and to tilt in a fourth direction when supplied to the fourth electrode.

Aspect 15: The method of any of aspects 10 through 14, wherein selectively supplying the first voltage signal and the second voltage signal further comprises selectively supplying, by the first selection component, the first voltage signal and the second voltage signal based at least in part on a received control signal.

Aspect 16: The method of any of aspects 10 through 15, further comprising: calibrating an ADC of the ASIC based at least in part on a first difference between a first voltage value measured by the ADC and a first expected voltage value that is based on a reference voltage source; outputting, by the ADC after calibration, a voltage value of the first voltage signal or the second voltage signal, wherein the voltage value is different than a second expected voltage value for the first voltage signal or the second voltage signal; modifying a digital setting of the first DAC until the voltage value equals the second expected voltage value; calculating a second difference between an expected digital setting of the first DAC corresponding to the second expected voltage value and the modified digital setting; and storing the second difference.

Aspect 17: The method of aspect 16, further comprising: generating, by the first DAC and based at least in part on the second difference, a third voltage signal for supplying to the one of the first electrode or the second electrode.

Aspect 18: The method of any of aspects 10 through 17, further comprising: adjusting, by one or more control logic of the ASIC, the first voltage signal, wherein adjusting the first voltage signal comprises controlling a step size and a duration of an input voltage to the first DAC; and supplying the input voltage to the first DAC, wherein the first DAC is configured to generate the first voltage signal for supplying to the one of the first electrode or the second electrode based at least in part on the input voltage.

Aspect 19: The method of any of aspects 10 through 18, wherein the first selection component is a MUX, a switch, or a selector.

Aspect 20: A method for fabricating an electronic device, comprising: forming a first substrate; disposing onto a first side of the first substrate one or more MEMS micromirrors; and disposing onto a second side of the first substrate one or more driver IC dies configured to transmit one or more driving signals to the one or more MEMS micromirrors, wherein each of the one or more driver IC dies comprises a first DAC configured to generate a first voltage signal for supplying to one of a first electrode or a second electrode electrically coupled to the one or more MEMS micromirrors, and wherein each of the one or more driver IC dies further comprises a first selection component configured to selectively supply the first voltage signal to one of the first electrode or the second electrode and a second voltage signal to the other of the first electrode or the second electrode to control a tilt of the one or more MEMS micromirrors, the one of the first electrode or the second electrode electrically coupling the first selection component to the one or more MEMS micromirrors.

Aspect 21: The method of aspect 20, wherein disposing onto the first side of the first substrate the one or more MEMS micromirrors further comprises disposing onto the first side of the first substrate an array of MEMS micromirrors.

Aspect 22: The method of any of aspects 20 through 21, wherein disposing onto the second side of the first substrate the one or more driver IC dies further comprises disposing onto the second side of the first substrate a plurality of driver IC dies.

Aspect 23: The method of any of aspects 20 through 21, wherein disposing onto the second side of the first substrate the one or more driver IC dies further comprises disposing onto the second side of the first substrate the one or more driver IC dies utilizing one or more of a wire-bonding process or a flip-chip bonding process.

Aspect 24: The method of any of aspects 20 through 23, wherein forming the first substrate further comprises forming a single substrate wafer, the single substrate wafer including one or more bonding pads on which to dispose the one or more MEMS micromirrors, one or more filtering components, and one or more conductive traces.

Aspect 25: The method of any of aspects 20 through 23, wherein the first substrate comprises a primary substrate for the electronic device or a secondary substrate associated with the primary substrate for the electronic device.

Aspect 26: The method of any of aspects 20 through 25, wherein the first selection component is a MUX, a switch, or a selector.

Aspect 27: A non-transitory computer-readable medium comprising instructions that, when executed by an ASIC, cause the ASIC to: generate, by a first DAC of the ASIC, a first voltage signal for supplying to one of a first electrode or a second electrode of a MEMS micromirror; receive, by a first selection component of the ASIC, the first voltage signal generated by the first DAC; receive, by the first selection component, a second voltage signal; and selectively supply, by the first selection component, the first voltage signal to one of the first electrode or the second electrode and the second voltage signal to the other of the first electrode or the second electrode to control a tilt of the MEMS micromirror.

Aspect 28: The non-transitory computer-readable medium of aspect 27, wherein the first voltage signal is configured to cause the MEMS micromirror to tilt in a first direction when supplied to the first electrode and to tilt in a second direction when supplied to the second electrode.

Aspect 29: The non-transitory computer-readable medium of any of aspects 27 through 28, wherein the instructions further cause the ASIC to receive the second voltage signal by receiving, by the first selection component, a ground voltage signal.

Aspect 30: The non-transitory computer-readable medium of any of aspects 27 through 29, wherein the instructions further cause the ASIC to: generate, by a second DAC of the ASIC, a third voltage signal for supplying to one of a third electrode or a fourth electrode of the MEMS micromirror; receive, by a second selection component of the ASIC, the third voltage signal generated by the second DAC; receive, by the second selection component, a fourth voltage signal; and selectively supply, by the second selection component, the third voltage signal to one of the third electrode or the fourth electrode and the fourth voltage signal to the other of the third electrode or the fourth electrode to control another tilt of the MEMS micromirror.

Aspect 31: The non-transitory computer-readable medium of aspect 30, wherein the third voltage signal is configured to cause the MEMS micromirror to tilt in a third direction when supplied to the third electrode and to tilt in a fourth direction when supplied to the fourth electrode.

Aspect 32: The non-transitory computer-readable medium of any of aspects 27 through 32, wherein the instructions further cause the ASIC to selectively supply, by the first selection component, the first voltage signal and the second voltage signal based at least in part on a received control signal.

Aspect 33: The non-transitory computer-readable medium of any of aspects 27 through 33, wherein the instructions further cause the ASIC to: calibrate an ADC of the ASIC based at least in part on a first difference between a first voltage value measured by the ADC and a first expected voltage value that is based on a reference voltage source; output, by the ADC after calibration, a voltage value of the first voltage signal or the second voltage signal, wherein the voltage value is different than a second expected voltage value for the first voltage signal or the second voltage signal; modify a digital setting of the first DAC until the voltage value equals the second expected voltage value; calculate a second difference between an expected digital setting of the first DAC corresponding to the second expected voltage value and the modified digital setting; and store the second difference.

Aspect 34: The non-transitory computer-readable medium of aspect 33, further comprising: generate, by the first DAC and based at least in part on the second difference, a third voltage signal for supplying to the one of the first electrode or the second electrode.

Aspect 35: The non-transitory computer-readable medium of any of aspects 27 through 34, wherein the instructions further cause the ASIC to: adjust, by one or more control logic of the ASIC, the first voltage signal, wherein adjusting the first voltage signal comprises controlling a step size and a duration of an input voltage to the first DAC; and supply the input voltage to the first DAC, wherein the first DAC is configured to generate the first voltage signal for supplying to the one of the first electrode or the second electrode based at least in part on the input voltage.

Aspect 36: The non-transitory computer-readable medium of any of aspects 27 through 35, wherein the first selection component is a MUX, a switch, or a selector.

Herein, a computer-readable non-transitory storage medium or media may include one or more semiconductor-based or other ICs (such, as for example, FPGAs or ASICs), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications, and equivalent arrangements.

The foregoing descriptions provide examples of different configurations and features of one or more embodiments. While certain nomenclature and types of applications/hardware are described, other names and application/hardware usage is possible, and the nomenclature is provided by way of non-limiting examples only. Further, while particular embodiments are described, it should be appreciated that the features and functions of each embodiment may be combined in any way that is within the capability of one skilled in the art. The figures provide additional exemplary details regarding the various embodiments.

The processes and logic flows described in this document can be performed by one or more programmable processors executing one or more computer programs to perform functions by operating on input data and generating output. The processes and logic flows can also be performed by an apparatus that can be implemented as a special purpose logic circuitry, e.g., an FPGA (field programmable gate array) or an ASIC (application-specific integrated circuit).

Computer-readable media suitable for storing computer program instructions and data can include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by or incorporated into special-purpose logic circuitry.

It will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. An electronic device, comprising:
a driver integrated circuit (IC) configured to transmit one or more driving signals to a microelectromechanical systems (MEMS) micromirror, comprising:
a first digital to analog converter (DAC) configured to generate a first voltage signal for supplying to one of a first electrode or a second electrode of the MEMS micromirror; and
a first selection component configured to:
receive the first voltage signal generated by the first DAC;
receive a second voltage signal; and
selectively supply the first voltage signal to one of the first electrode or the second electrode and the second voltage signal to the other of the first electrode or the second electrode to control a tilt of the MEMS micromirror.

2. The electronic device of claim 1, wherein the first voltage signal is configured to cause the MEMS micromirror to tilt in a first direction when supplied to the first electrode and to tilt in a second direction when supplied to the second electrode.

3. The electronic device of claim 1, wherein the second voltage signal comprises a ground voltage signal.

4. The electronic device of claim 1, wherein the driver IC comprises a first driver IC, and wherein the electronic device further comprises:
a second driver IC configured to transmit one or more driving signals to the MEMS micromirror, comprising:
a second DAC configured to generate a third voltage signal for supplying to one of a third electrode or a fourth electrode of the MEMS micromirror; and
a second selection component configured to:
receive the third voltage signal generated by the second DAC;
receive a fourth voltage signal; and
selectively supply the third voltage signal to one of the third electrode or the fourth electrode and the fourth voltage signal to the other of the third electrode or the fourth electrode to control another tilt of the MEMS micromirror.

5. The electronic device of claim 4, wherein the third voltage signal is configured to cause the MEMS micromirror to tilt in a third direction when supplied to the third electrode and to tilt in a fourth direction when supplied to the fourth electrode.

6. The electronic device of claim 1, wherein the first selection component is further configured to selectively supply the first voltage signal and the second voltage signal based at least in part on a received control signal.

7. The electronic device of claim 1, further comprising an analog to digital converter (ADC) configured to perform an autocalibration of the first DAC based at least in part on the first voltage signal or the second voltage signal.

8. The electronic device of claim 1, wherein the driver IC comprises one of an application-specific integrated circuit (ASIC), a field-programmable gate array (FPGA), or a microcontroller.

9. The electronic device of claim 1, wherein the first selection component is a multiplexer (MUX), a switch, or a selector.

10. A method implemented by an application-specific integrated circuit (ASIC), the method comprising:
generating, by a first digital to analog converter (DAC) of the ASIC, a first voltage signal for supplying to one of a first electrode or a second electrode of a microelectromechanical systems (MEMS) micromirror;
receiving, by a first selection component of the ASIC, the first voltage signal generated by the first DAC;
receiving, by the first selection component, a second voltage signal; and
selectively supplying, by the first selection component, the first voltage signal to one of the first electrode or the second electrode and the second voltage signal to the other of the first electrode or the second electrode to control a tilt of the MEMS micromirror.

11. The method of claim 10, wherein the first voltage signal is configured to cause the MEMS micromirror to tilt in a first direction when supplied to the first electrode and to tilt in a second direction when supplied to the second electrode.

12. The method of claim 10, wherein receiving the second voltage signal comprises receiving, by the first selection component, a ground voltage signal.

13. The method of claim 10, further comprising:
generating, by a second DAC of the ASIC, a third voltage signal for supplying to one of a third electrode or a fourth electrode of the MEMS micromirror;
receiving, by a second selection component of the ASIC, the third voltage signal generated by the second DAC;
receiving, by the second selection component, a fourth voltage signal; and
selectively supplying, by the second selection component, the third voltage signal to one of the third electrode or the fourth electrode and the fourth voltage signal to the other of the third electrode or the fourth electrode to control another tilt of the MEMS micromirror.

14. The method of claim 13, wherein the third voltage signal is configured to cause the MEMS micromirror to tilt in a third direction when supplied to the third electrode and to tilt in a fourth direction when supplied to the fourth electrode.

15. The method of claim 10, wherein selectively supplying the first voltage signal and the second voltage signal further comprises selectively supplying, by the first selection component, the first voltage signal and the second voltage signal based at least in part on a received control signal.

16. The method of claim 10, further comprising:
calibrating an analog to digital converter (ADC) of the ASIC based at least in part on a first difference between a first voltage value measured by the ADC and a first expected voltage value that is based on a reference voltage source;
outputting, by the ADC after calibration, a voltage value of the first voltage signal or the second voltage signal, wherein the voltage value is different than a second expected voltage value for the first voltage signal or the second voltage signal;
modifying a digital setting of the first DAC until the voltage value equals the second expected voltage value;
calculating a second difference between an expected digital setting of the first DAC corresponding to the second expected voltage value and the modified digital setting; and
storing the second difference.

17. The method of claim 16, further comprising:
generating, by the first DAC and based at least in part on the second difference, a third voltage signal for supplying to the one of the first electrode or the second electrode.

18. The method of claim 10, further comprising:
adjusting, by one or more control logic of the ASIC, the first voltage signal, wherein adjusting the first voltage signal comprises controlling a step size and a duration of an input voltage to the first DAC; and
supplying the input voltage to the first DAC, wherein the first DAC is configured to generate the first voltage signal for supplying to the one of the first electrode or the second electrode based at least in part on the input voltage.

19. The method of claim 10, wherein the first selection component is a multiplexer (MUX), a switch, or a selector.

20. A non-transitory computer-readable medium comprising instructions that, when executed by an application-specific integrated circuit (ASIC), cause the ASIC to:
generate, by a first digital to analog converter (DAC) of the ASIC, a first voltage signal for supplying to one of a first electrode or a second electrode of a microelectromechanical systems (MEMS) micromirror;
receive, by a first selection component of the ASIC, the first voltage signal generated by the first DAC;
receive, by the first selection component, a second voltage signal; and
selectively supply, by the first selection component, the first voltage signal to one of the first electrode or the second electrode and the second voltage signal to the other of the first electrode or the second electrode to control a tilt of the MEMS micromirror.
